(19) United States
(12) Patent Application Publication
(10) Pub. No.: US 2010/0193555 A1
(43) Pub. Date: Aug. 5, 2010

(54) Auxiliary support device for a vehicle

(76) Inventor: G. Kyle Gift, Virginia Beach, VA (US)

Correspondence Address: WILLIAMS G. SYKES, 3669 SEAGULL BLUFF DRIVE, VIRGINIA BEACH, VA, 23455, US

(21) Appl. No.: 12/322,313

(22) Filed: Feb. 2, 2009

(51) Int. Cl. B60R 9/058; B60R 9/06

(52) U.S. Cl. 224/321; 224/322; 224/324; 224/329; 224/572; 414/800

(57) ABSTRACT

A carrier for elongated cargos, especially recreational cargos such as canoes, kayaks, long wind resistant loads, surf or paddle boards, etc. suitable for use on automobiles having a trunk-mounted, adjustable height support for supporting the rear portion of the elongated cargo in cooperation with a traditional roof mounted cargo rack on the top of the automobile. The trunk-mounted support may be height adjustable to ensure universal compatibility with different automobiles and with various roof-top carriers. The height adjustability feature also helps position the elongated cargo at an angle to control aerodynamic effects to help ensure the stability of the elongated cargo on the support system, even at highway speeds. The trunk-mounted support design eliminates the need for a bumper or trailer hitch attachment, such bumper attachments being impossible on many modern automobiles. The trunk-mounted support is both easy to install and to adjust.

### FIELD OF THE INVENTION

The invention pertains to support racks for motor vehicles and, more particularly, to an auxiliary support device for use cooperatively with a vehicle roof rack to support long objects on a vehicle.

1. Background of the Invention

Owners of compact vehicles have long faced a problem supporting and safely transporting long objects. Heretofore, a classic roof rack has been utilized to support canoes, kayaks, long surf or paddle boards, lumber, long ladders, long lengths of pipe, etc. on their vehicles. When roof racks alone have been utilized, the cargo typically overhangs both the front and rear edges of the roof rack. While such arrangements may suffice for short distance and/or low speed travel, they are highly unsatisfactory for long distance trips and when transporting “air-resistant cargo”, typically accomplished at highway speeds. At highway speeds, the cargos supported using only a roof rack may become unstable. This instability may result in damage to or loss of the cargo as well as possible damage to the vehicle carrying the cargo. In cases where the cargo separates from the roof rack, other vehicles may be damages and serious accidents may consequently occur.

2. Discussion of the Related Art

Many attempts at providing support for long cargos on vehicles may be found in the prior art. For example, U.S. Pat. No. 2,785,816 for LOADER AND CARRY-ALL FOR AUTOMOBILES, issued Mar. 19, 1957 to Ray Fisher teaches a carrier having a rear portion attached to a rear bumper of an automobile. The rear carrier portion both tilts and swivels to facilitate loading the cargo. A front carrier portion is a typically roof-top carrier supported on the vehicle rooftop near the front of the roof.

U.S. Pat. No. 2,895,628 for BOAT LOADER FOR AUTOMOBILES, issued Jul. 21, 1959 to Leonard J. Gebhart discloses a loader and carrier similar to the FISHER carrier discussed hereinabove. The GEBHART carrier also has a rear bumper mounted portion and a front, roof mounted portion.

U.S. Pat. No. 3,321,095 for REMOVABLE LOAD SUPPORTING RACK FOR AUTOMOBILES, issued May 23, 1967 to Walter H. Groll provides a two-part support system, a front portion mounted on the automobile hood adjacent to the windshield, the second portion mounted on the trunk adjacent the vehicle's rear window.

U.S. Pat. No. 3,709,413 for CAR TRUNK RACK, issued Jan. 9, 1973 to Ralph R. Nelson shows an apparatus having a front, roof-supported portion and a rear, trunk-supported member joined by a rigid connecting member.

U.S. Pat. No. 3,712,524 for BOAT LOADER FOR AUTOMOBILES, issued Jan. 23, 1973 to Russell K. Ames, Sr. teaches a trunk-mounted roller structure to facilitate loading a boat onto a roof-top carrier. The roller structure provides no support to the cargo during transport.

U.S. Pat. No. 4,168,023 for VEHICLE LUGGAGE RACK, issued Sep. 18, 1979 to Jack R. Osborn teaches a roof-top carrier specifically adapted for use with a vehicle having a landau roof.

U.S. Pat. No. 4,406,384 for DETACHABLE LOAD CARRIER FOR A VEHICLE, issued Sep. 27, 1983 to Lawrence F. Schantz provides a rear bumper-mounted load carrier. A support structure mounted on the vehicles is used to stabilize and support the load carried on the bumper-mounted portion.

U.S. Pat. No. 4,527,827 for VEHICLE RACK FOR SURFING BOARD, issued Jul. 9, 1985 to Jack E. Maniscalco et al. provides a rear support for a pickup truck to carry an elongated cargo.

U.S. Pat. No. 4,630,990 for DEVICE AND METHOD FOR LOADING AND TRANSPORTING ELONGATE OBJECTS ON THE TOPS OF VEHICLES, issued to Montague Whiting discloses another rear support for a pickup truck to allow carrying an elongated cargo.

U.S. Pat. No. 5,292,045 for MULTIPURPOSE RACK FOR CONVERTIBLE TOP VEHICLES, issued Mar. 8, 1994 to F. Howard Mandel teaches a cargo support system having a front support portion attached to the vehicle windshield and a rear support portion mounted to the rear deck of the vehicle.

U.S. Pat. No. 5,649,656 for RECEIVER HITCH BOAT AND CANOE RACK, issued Jul. 22, 1997 to Charles E. Davy provides still another support device for a pickup truck to facilitate carrying an elongated cargo. The DAVY apparatus attaches to the rear bumper of the pickup truck.

U.S. Pat. No. 6,237,824 for RACK SYSTEM FOR A VEHICLE, issued May 29, 2001 to Steve M. Bagley shows yet another attachment for the rear bumper of a pickup truck to facilitate the transport of elongated cargos.

None of the patents and published patent applications, taken singly, or in any combination are seen to teach or suggest the novel cargo support system of the present invention.

### SUMMARY OF THE INVENTION

In accordance with the present invention there is provided a carrier for elongated cargos, especially recreational cargos such as canoes, kayaks, surf or paddle boards, etc. suitable for use on automobiles. A trunk-mounted, adjustable height support member supports the rear portion of the cargo in cooperation with a traditional roof mounted cargo rack on the top of the automobile. The trunk-mounted device is height adjustable to ensure universal compatibility with cars and various roof-top carriers. The height adjustability feature also helps position the elongated cargo at an angle to control aerodynamic effects to help ensure the stability of the elongated cargo on the support system, even at highway speeds. The novel design eliminates the need for a bumper attachment, such bumper attachments being impossible on many modern automobiles. The novel carrier system is easy to install and adjust. It also eliminates the need for a trailer hitch connection, many vehicles will not accept or permit a trailer hitch.

It is, therefore, an object of the invention to provide a trunk-mounted carrier component for cooperative use with a roof-top carrier for supporting an elongated cargo on the top of a vehicle.

It is another object of the invention to provide a trunk-mounted carrier component for cooperative use with a roof-top carrier useful for carrying a canoe, kayak, surf or paddle board, or other elongated recreational device.

It is an additional object of the invention to provide a trunk-mounted carrier component for cooperative use with a roof-top carrier that is height-adjustable to allow universal use with any automobile and/or roof-top carrier.

It is a further object of the invention to provide a trunk-mounted carrier component for cooperative use with a roof-top carrier that is height-adjustable to allow adjusting the elongated cargo for optimum aerodynamic performance and stability.

It is a still further object of the invention to provide a trunk-mounted carrier component for cooperative use with a roof-top carrier useful for safely supporting and retaining an elongated cargo at highway speeds.

It is yet another object of the invention to provide a trunk-mounted carrier component for cooperative use with a roof-top carrier that eliminates the need for attachment to the bumper or trailer hitch of a vehicle.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a top, perspective view of the trunk-mounted component of the invention;

FIG. 2 is a bottom, perspective view of the trunk-mounted component of FIG. 1;

FIG. 3 is a right-side elevational environmental view of the trunk-mounted component of the elongated cargo support system of the invention;

FIG. 4 is a rear perspective environmental view of the trunk-mounted component of the elongated cargo support system of FIG. 3; and

FIG. 5 is a right rear perspective environmental view of the trunk-mounted component of the elongated cargo support system of FIG. 3.

### DETAILED DESCRIPTION OF THE PREFERRED EMBODIMENT

The present invention provides a trunk-mounted component for use in cooperation with a roof-top carrier to form a novel support system for an elongated carrier.

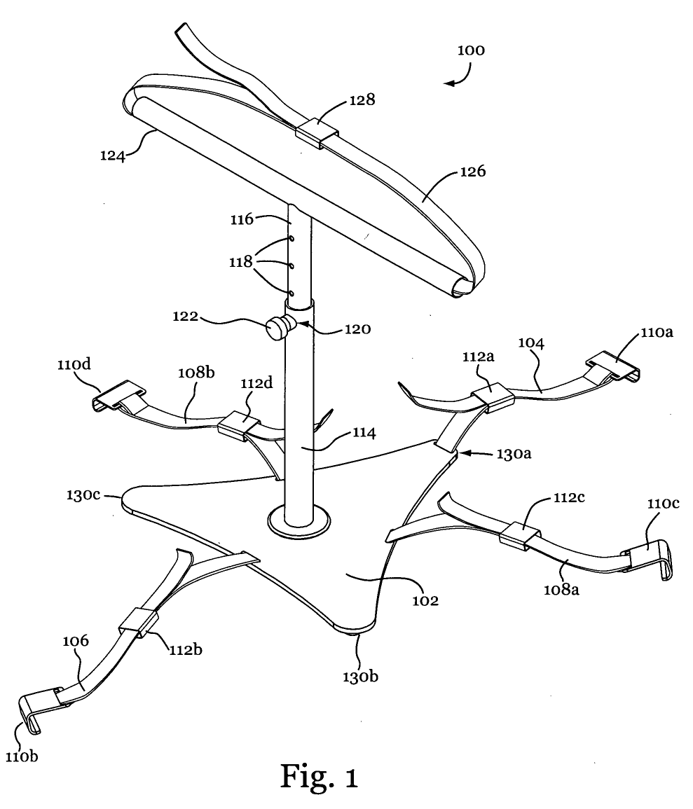

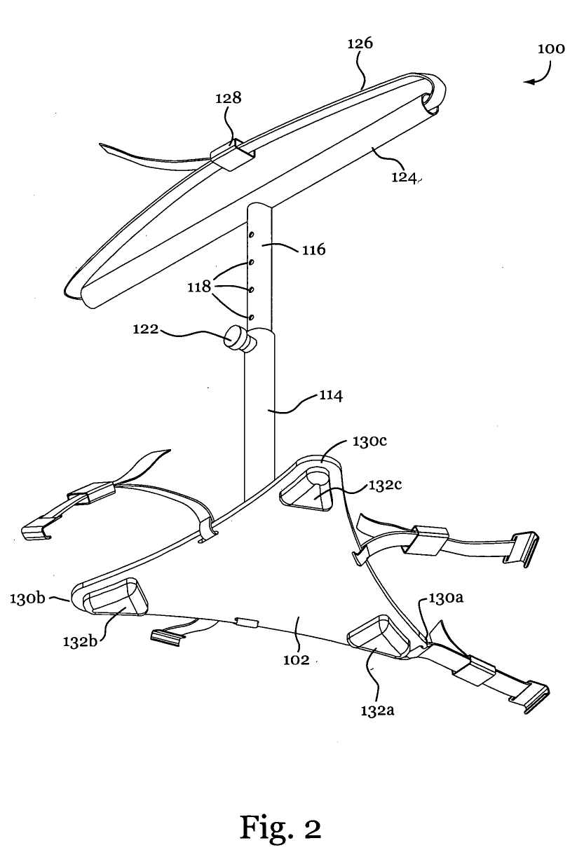

Referring first to FIGS. 1 and 2, there are shown top and bottom perspective views, respectively of a trunk-mounted component of the novel elongated cargo support system in accordance with the present invention, generally at reference number 100.

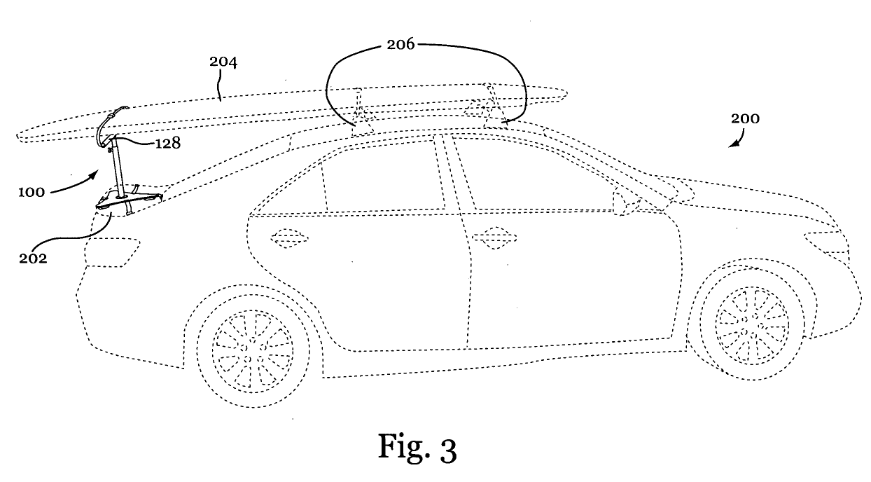

A generally triangular base 102 has vertices 130, 130b, 130c. Proximal ends of fore securing strap 104, aft securing strap 106, and right and left securing straps 108a, 108b, respectively are secure to triangular base 102 so as to orient vertex 130a in a forward-facing direction (see FIG. 3) when trunk-mounted support 100 is installed on an automobile 200 (FIG. 3). The choice of a triangular shape for base 102 and the particular orientation chosen for purposes of disclosure distributes weight imposed by a supported cargo, for example surfboard 204 (FIG. 3) on the rear edge of trunk deck or lid 202 (FIG. 3). The rear edge of trunk deck 202 is considered the most able region to bear weight without deformation. It will, however, be recognized that other shapes and/or orientations of a base may be chosen to meet a particular operating circumstance or environment. The invention is not, therefore, considered limited to the triangular base plate or orientation thereof chosen for purposes of disclosure. Rather, the invention includes any suitable base shape and/or orientation.

Fore securing strap 104, aft securing strap 106, and right and left securing straps 108a, 108b, respectively are slidably attached to respective trunk edge securing clips 110a, 110b, 110c, 110d, respectively. Suitable trunk edge securing clips are believed to be known to those of skill in the art and are not further discussed or described herein.

Length adjustment/tensioning mechanisms 112a, 112b, 112c, and 112d are disposed on respective ones of fore securing strap 104, aft securing strap 106, and right and left securing straps 108a, 108b, respectively. Such length adjustment mechanisms are believed to be well known to those of skill in the art and, consequently, are not further discussed herein. It will be recognized that any suitable mechanism may be utilized to perform the length adjusting and/or tensioning function(s).

A hollow cylindrical support post base section 114 is centrally and substantially perpendicularly disposed on an upper surface of triangular base 102. An upper, adjustable support post member 116 is sized and configured for slidable reception within support post base section 114. It will be recognized that while a cylindrical shape has been chosen for support post base section 114 and support post and upper adjustable section 116, other shapes, for example, square or rectangular, may be chosen. Consequently, the invention is seen to include any suitable support post cross-sectional shape and is not limited to the circular cross-sectional shape chosen for purposes of disclosure.

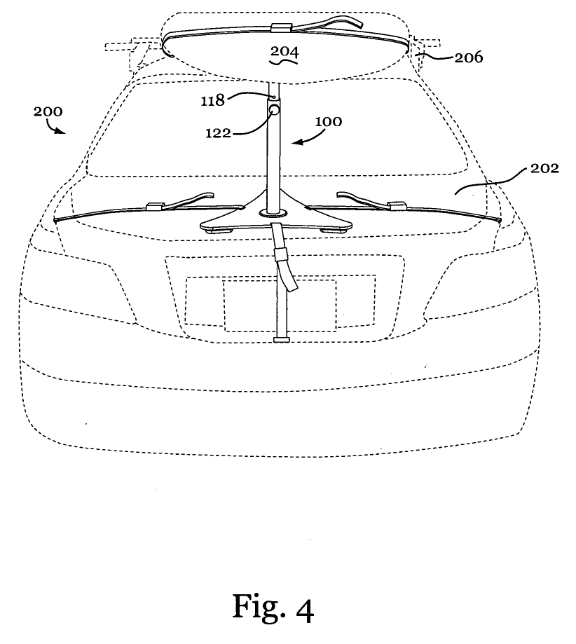

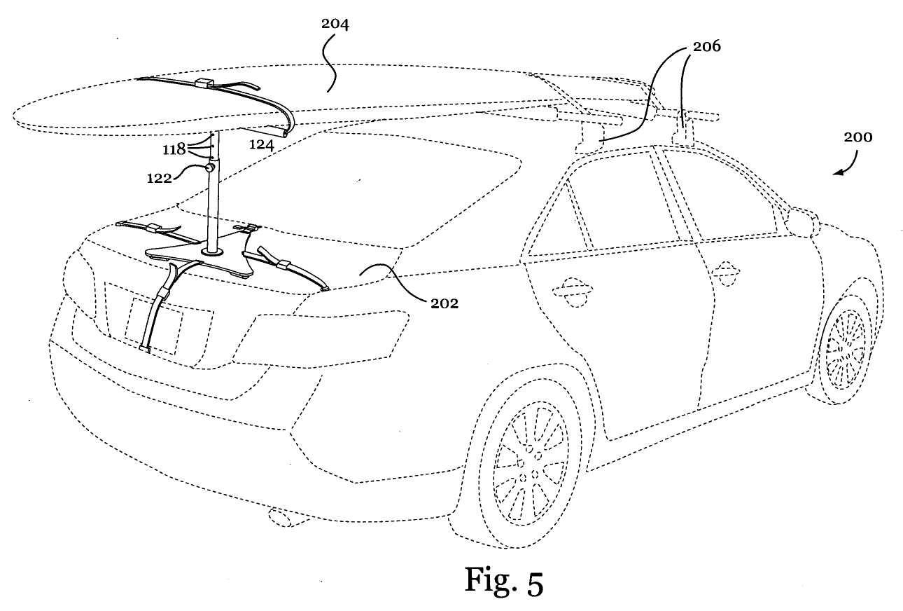

Referring now to FIGS. 3, 4, and 5, there are shown right side, rear, and right rear environmental, perspective views, respectively of the trunk mounted support of the invention in its intended operating environment. An automobile 200 having a trunk deck or lid 202 is equipped with a conventional two-piece rooftop carrier 206. The front portion of a surfboard, paddleboard or long wind resistant load 204 is supported by rooftop carrier 206. A rear portion of surfboard, paddleboard or long wind resistant load 204 is supported by trunk-mounted component 100 that is, in turn, secured to trunk deck 202 of automobile 200. Neither automobile 200 nor surfboard, paddleboard or long wind resistant load 204 form any part of the present invention.

For purposes of illustration, car top carrier 206 that also forms no part of the present invention, is a two-piece carrier. Such carriers are believed to be well known to those of skill in the art and are not further discussed herein. It will, however, be recognized that many alternate styles or configurations of car top carrier may, of course, be utilized cooperatively with the trunk-mounted support of the invention.

Refer now also to FIGS. 1 and 2. In operation, roof-top carrier 206 is first attached to automobile 200 in accordance with standard practice.

Trunk-mounted component 100 is attached to trunk deck 202 of automobile 200 by engaging respective edges thereof with trunk lid securing clips 110a, 110b, 110c, 110d. Respective length adjusting mechanisms are next adjusted to position and secure base 102 as desired on trunk deck 202.

Once trunk-mounted support 100 is secures to trunk deck 202, a cargo, for example, surfboard, paddleboard or long wind resistant load 204 may be lifted onto rooftop carrier 206 and tee support member 124 of trunk-mounted support 100. Securing strap 126, in cooperation with securing clasp/length adjuster 128 is utilized to secure a rear portion of surfboard, paddleboard or long wind resistant load 120 to tee support member 124.

The height of trunk-mounted support 100 may be adjusted as required by moving upper, adjustable section 116 in support post base section 114 until the height of tee support member 124 is positioned as desired relative to rooftop carrier 206. The relationship of support post upper, adjustable section 116 relative to support post base section 114 is maintained by height securing mechanism 122 in cooperation with support post base section securing hole and a selected one of post adjustment holes 118.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A support component for a rooftop carrier system for carrying an elongated cargo on an automobile, comprising:
a) a substantially planar base for installation on an upward-facing surface of a deck of a trunk of an automobile;
b) means for removably securing said substantially planar base to said upward-facing surface of said trunk deck;
c) a support post having a proximal end connected to said substantially planar base, said support post projecting upwardly from an upper surface thereof; and
d) a tee-support member attached to a distal end of said support post, said tee-support member being disposed substantially perpendicular to a major axis of said support post.

2. The support component for a rooftop carrier system as recited in claim 1, wherein said proximal end of said support post is affixed to said substantially planar base.

3. The support component for a rooftop carrier system as recited in claim 1, wherein said support post comprises a first portion and a second portion movable with respect to said first portion so as to adjust the overall length of said support post.

4. The support component for a rooftop carrier system as recited in claim 3, wherein said first portion is hollow and has a predetermined inside cross-sectional dimension, and said second portion is sized and configured for slidable reception within said first, hollow portion.

5. The support component for a rooftop carrier system as recited in claim 5, further comprising:
a) a securing mechanism operatively connected to said first portion of said support post and said second portion of said support post to adjustably maintain a positional relationship therebetween.

6. The support component for a rooftop carrier system as recited in claim 1, wherein said means for removably securing said substantially planar base to said upward-facing surface of said trunk deck comprises:
a) a plurality of attachment straps, each having a proximal end attached to said substantially planar base;
b) a trunk edge securing clip slidably connected to each of said plurality of straps; and
c) a length adjusting mechanism disposed on each of said plurality of straps.

7. The support component for a rooftop carrier system as recited in claim 6, wherein said substantially planar base is substantially triangular in shape.

8. The support component for a rooftop carrier system as recited in claim 7 wherein at the distal end of at least one of proximal ends of said plurality of attachment straps comprises a fore attachment strap attached to a vertex of said substantially triangular, substantially planar base.

9. The support component for a rooftop carrier system as recited in claim 1, wherein said substantially planar base comprises:
a) at least one anti-scratch pad disposed on a downward-facing surface of said substantially planar base.

10. The support component for a rooftop carrier system as recited in claim 1, wherein said tee-support member comprise an attachment strap operatively connected thereto.

11. A method of transporting an elongated cargo atop an automobile, the steps comprising:
a) providing a conventional rooftop carrier and attaching said conventional rooftop carrier to the roof of an automobile;
b) providing a trunk-mounted support comprising a substantially planar base, a support post projecting vertically from an upper surface of said substantially planar support base, a tee support member affixed to a distal end of said support post, and means for securing said substantially planar base to a upward-facing surface of a trunk deck of an automobile;
c) using said means for securing, attaching said trunk-mounted support to said upward-facing surface of said trunk deck; and
d) supporting an elongated cargo on both said conventional rooftop carrier and said tee support-member of said trunk-mounted support.

12. The method of transporting an elongated cargo atop an automobile as recited in claim 11, wherein said providing step (b) comprises supplying a trunk-mounted support wherein said support post comprises an adjustable length support post.

13. The method of transporting an elongated cargo atop an automobile as recited in claim 12, the steps further comprising:
a) adjusting the length of said adjustable length post of said support post so that said tee support has a desired height relationship to said conventional rooftop carrier.
